(19) United States
(12) Patent Application Publication
(10) Pub. No.: US 2019/0261579 A1
(43) Pub. Date: Aug. 29, 2019

(54) PLANT FROST SHIELD DEVICE WITH REMOVABLE COVER LAYER AND RELATED METHODS

(71) Applicant: DOUGLAS R. BROWN, Fort White, FL (US)

(72) Inventor: DOUGLAS R. BROWN, Fort White, FL (US)

(21) Appl. No.: 16/270,820

(22) Filed: Feb. 8, 2019

Related U.S. Application Data
(60) Provisional application No. 62/628,371, filed on Feb. 9, 2018.

(51) Int. Cl. A01G 13/02

(52) U.S. Cl. CPC A01G 13/0243

(57) ABSTRACT

A frost shield device may include a base having blocks. At least some of the blocks each may define a first through passageway and a second through passageway. The frost shield device may have poles, each pole having a first end to be received by one of the first through passageway and the second through passageway, and a second end. The frost shield device may also include a top ring coupled to the second ends of the poles, and a cover layer configured to extend from the base to the top ring, thereby covering a plant within the base.

### RELATED APPLICATION

This application is based upon prior filed copending Application No. 62/628,371 filed Feb. 9, 2018, the entire subject matter of which is incorporated herein by reference in its entirety.

### TECHNICAL FIELD

The present disclosure relates to the field of landscaping and garden tools, and, more particularly, to landscaping accessories and related methods.

### BACKGROUND

The landscaping industry is a large and robust industry worldwide. Although the demand for commercial landscaping is quite large, the residential landscaping industry is arguably more robust and diverse. In fact, the residential landscaping industry has spawned several large business sectors, such as the residential landscaping maintenance industry, the residential irrigation maintenance industry, and the landscaping device industry (i.e. lawn mowers, landscaping accessories, lawn care items).

The landscaping accessories industry is quite mature and spans a wide continuum of devices, varying from portable irrigation devices to manual cultivation tools. Once such landscaping accessory is a frost shield for plants and small trees. Some plants and small trees may suffer damage when the ambient temperature drops below a threshold temperature (e.g. the freezing point of water: 32° F. or 0° C.). To protect the plants and small trees from damage, the frost shield is deployed thereover. In most approaches, the frost shield is a simple weather proof blanket for the plants and small trees.

On drawback these typical approaches is inconvenience. In particular, the frost shield must be deployed and removed regularly to keep the plants and small trees in a healthy state. Of course, in many applications, the residential user may not redeploy the frost shield promptly or leave the frost shield on too long, each scenario damaging the plant.

### SUMMARY

Generally, a frost shield device may include a base comprising a plurality of blocks. At least some of the plurality of blocks each may define a first through passageway and a second through passageway. The frost shield device may comprise a plurality of poles. Each pole may have a first end to be received by one of the first through passageway and the second through passageway, and a second end. The frost shield device may also include a top ring coupled to the second ends of the plurality of poles, and a cover layer configured to extend from the base to the top ring, thereby covering a plant within the base.

In particular, the plurality of blocks may comprise a plurality of cap blocks, a plurality of base blocks, and a plurality of medial blocks between the plurality of cap blocks and the plurality of base blocks. The frost shield device may also comprise a plurality of plug connectors carried within the first through passageway and the second through passageway of each cap block. In some embodiments, each of the plurality of plug connectors may include a lower body defining a plurality of lower radial protrusions, an upper body defining an eyelet, and a disc-shaped medial portion between the lower body and the upper body.

Furthermore, the frost shield device may also include a plurality of connectors carried within the first through passageway and the second through passageway of each base block and medial block and vertically coupling adjacent blocks. Each of the plurality of connectors may include a lower body defining a plurality of lower radial protrusions, an upper body defining a plurality of upper radial protrusions, and a disc-shaped medial portion between the lower body and the upper body.

Each base block may comprise a first end and a second end opposing the first end defining an interlocking interface. Each of the first and second through passageways may have an outer diameter, and an inner diameter less than the outer diameter. Each of the first and second through passageways may have a longitudinal channel extending partially therein.

Another aspect is directed to a method of making a frost shield device. The method may comprise forming a base comprising a plurality of blocks. At least some of the plurality of blocks may each define a first through passageway and a second through passageway. The method may comprise forming a plurality of poles. Each pole may have a first end to be received by one of the first through passageway and the second through passageway, and a second end. The method may include coupling a top ring to the second ends of the plurality of poles, and forming a cover layer configured to extend from the base to the top ring, thereby covering a plant within the base.

### BRIEF DESCRIPTION OF THE DRAWINGS

FIG. 1 is a schematic perspective view of a frost shield device, according to the present disclosure.

FIG. 2 is a schematic side view of the frost shield device of FIG. 1.

FIG. 3A is a schematic top plan view of the blocks from the frost shield device of FIG. 1 without the upper blocks.

FIG. 3B is a schematic side view of the blocks from the frost shield device of FIG. 1 with the upper blocks.

FIG. 4A is a schematic side view of a plug from the frost shield device of FIG. 1.

FIG. 4B is a schematic bottom plan view of the plug from FIG. 4A.

FIG. 5A is a schematic side view of another embodiment of the plug from the frost shield device of FIG. 1.

FIG. 5B is a schematic bottom plan view of the plug from FIG. 5A.

FIGS. 6-8 are schematic top plan views of the blocks from the frost shield device of FIG. 1.

FIG. 9 is a schematic side view of a vertical block connector from the frost shield device of FIG. 1.

FIG. 10 is a schematic side view of a block hollowing jig device, according to the present disclosure.

FIG. 11 is a schematic side view of the block hollowing jig device in the upper block, according to the present disclosure.

FIG. 12 is a schematic exploded view of another embodiment of the base from the frost shield device, according to the present disclosure.

FIG. 13A is a schematic perspective view of the base block from the frost shield device in FIG. 12.

FIGS. 13B-13D are schematic perspective views of the through passageway in the base block from the frost shield device in FIG. 12.

FIG. 14 is a schematic perspective view of the medial block from the frost shield device in FIG. 12.

FIG. 15 is a schematic perspective view of the cap block from the frost shield device in FIG. 12.

FIGS. 16A-16C are schematic perspective views of the connector from the frost shield device in FIG. 12.

FIGS. 17A-17B are schematic perspective views of the plug connector from the frost shield device in FIG. 12.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

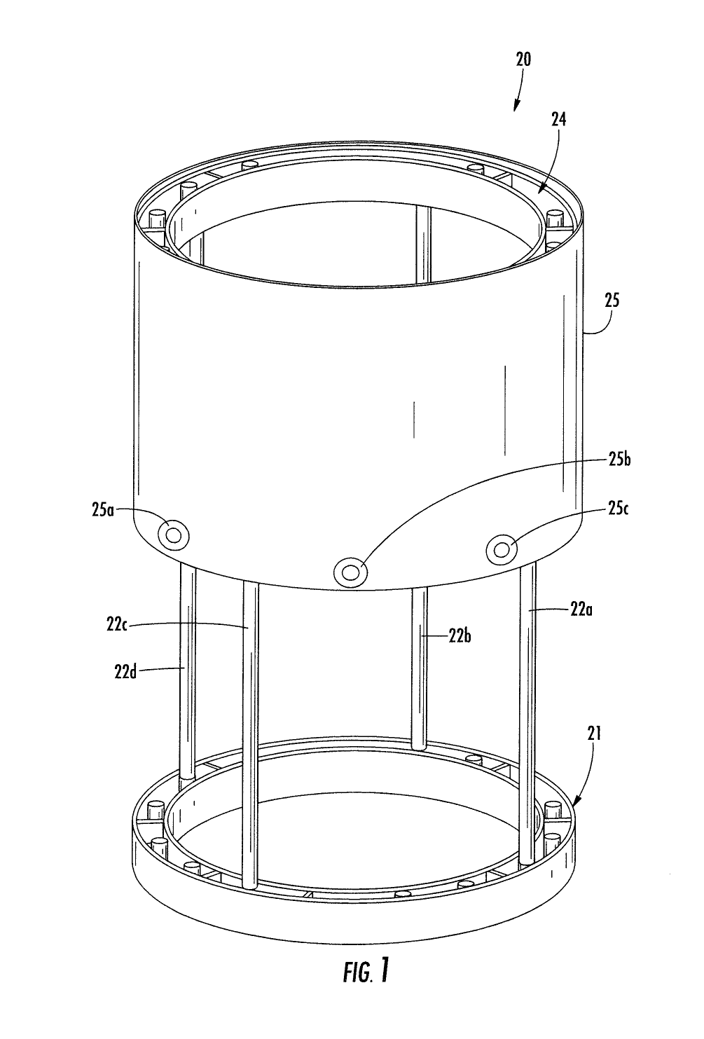

Referring initially to FIGS. 1-4B and FIGS. 6-9, a frost shield device 20 according to the present disclosure is now described. The frost shield device 20 illustratively includes a circular base 21 comprising a plurality of blocks 29a-29b, 31, 34 and configured to house a plant or small tree. The plurality of blocks 29a-29b, 31, 34 comprises bottom blocks 31, middle (i.e. regular) blocks 29a-29b, and upper (i.e. cap) blocks 34, 34a-34c. As perhaps best seen in FIGS. 6-7, each of the bottom and middle blocks 31, 29a-29c each illustratively defines first and second through passageways 33a-33b, 39a-39b. The first and second through passageways 33a-33b, 39a-39b are each stepped, and have an inner diameter less than an outer diameter.

Also, each of the bottom blocks 31 illustratively includes a dovetail interface or tongue and groove interface having a groove 30, and a tongue 38 on opposing ends thereof. Also, each of the bottom blocks 31 may include one or more ports for watering the plant within the circular base 21.

When the circular base 21 is assembled, the row of bottom blocks 31 is mechanically sound due to the tongue and groove interface. Moreover, one or more stakes 28 are driven into a ground surface to anchor the circular base 21.

It should be appreciated that that the circle shape of circular base 21 is exemplary in nature. In other embodiments, the circular base 21 may be rectangle-shaped, triangle-shaped, or polygon-shaped. Of course, each of the plurality of blocks 29a-29b, 31, 34 may take on other shapes to enable such embodiments. In other words, each of the plurality of blocks 29a-29b, 31, 34 may be straight, curved, or take on an L-shape for corners, for example.

In some embodiments, each of the plurality of blocks 29a-29b, 31, 34 is hollow and integrally formed, such as from an injected molded plastic process, for example. In other embodiments, the plurality of blocks 29a-29b, 31, 34 may be solid.

In some embodiments, the plurality of blocks 29a-29b, 31, 34 each comprises a weather resistant plastic polymer material. For example, the weather resistant plastic polymer may be chemically hardened so as not to fade or crack when exposed to outdoor elements, such as heat, water, and ultraviolet (UV) radiation. Also, in some embodiments, each of the plurality of blocks 29a-29b, 31, 34 has a textured outer body to provide a paver stone look, i.e. to give an appearance of comprising a naturally occurring material (e.g. stone, or granite). Additionally, the plurality of blocks 29a-29b, 31, 34 each comprises a stone veneer.

The frost shield device 20 illustratively includes a plurality of poles 22a-22d. Each pole 22a-22d illustratively includes a first end to be received by one of the first and second through passageways 33a-33b, 39a-39b of the bottom and middle blocks 31, 29a-29c, and a second end. In some embodiments, each pole 22a-22d comprises a hollow plastic polymer tube, for example, 80 PVC conduit tubing. In other embodiments, each pole 22a-22d may be solid, and/or comprise other materials, such a metallic material.

The frost shield device 20 illustratively includes a top ring 24 coupled to the second ends of the plurality of poles 22a-22d, and a cover layer 23. The cover layer 23 is configured to extend from the circular base 21 to the top ring 24, thereby covering the plant or small tree within the circular base. Advantageously, the frost shield device 20 may be readily deployed and retracted.

In some embodiments, the cover layer 23 may include decorative elements on an outer surface thereof, such as athletic team logos, school logos, and flag emblems. The cover layer 23 may comprise a plastic polymer material, or tarpaulin material, for example.

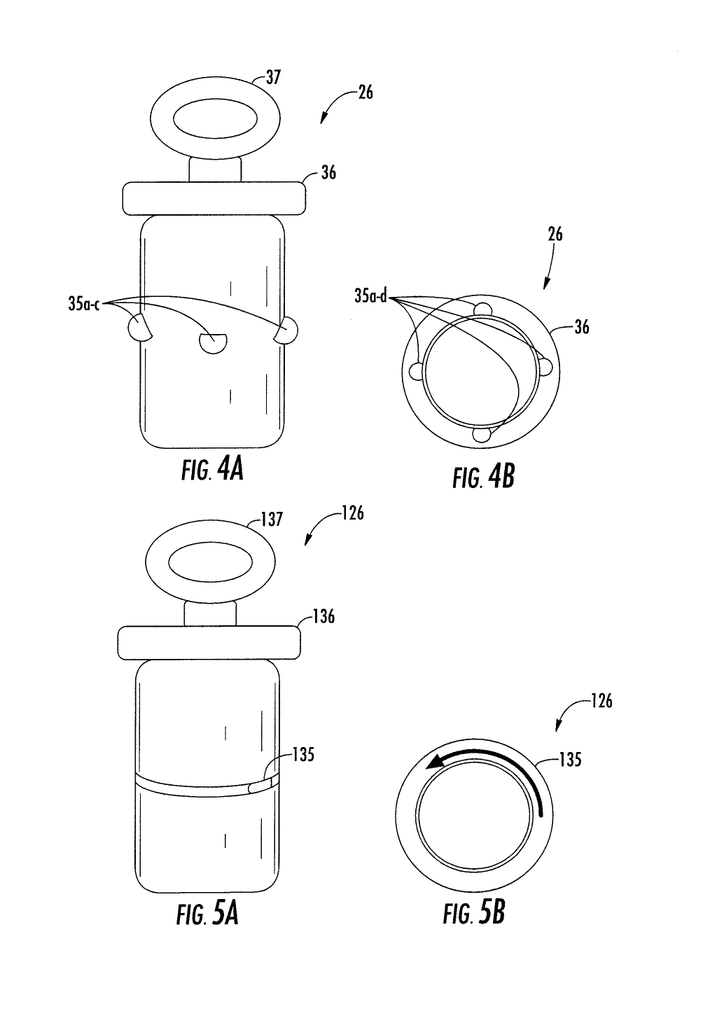

As perhaps best seen in FIGS. 4A-4B, the frost shield device 20 illustratively includes a plurality of plugs 26. Each plug 26 illustratively includes a lower body defining a plurality of radial protrusions 35a-35d, an upper body defining an eyelet 37, and a disc-shaped medial portion 36 between the lower body and the upper body.

As perhaps best seen in FIG. 2, the top ring 24 illustratively includes a plurality of bottom blocks positioned together. The second end of each of the plurality of poles 22a-22d extends through a respective through passageway of the bottom block and extends partially out the opposite side. The plug 26 is inserted over the second end of each of the plurality of poles 22a-22d, and interface fits over the pole and within the through passageway. The interface fit is provided by operation of the plurality of radial protrusions 35a-35d and corresponding radial indentations within the through passageways. In other embodiments, the top ring 24 may comprise an integral body configured to receive the second end of each of the plurality of poles 22a-22d.

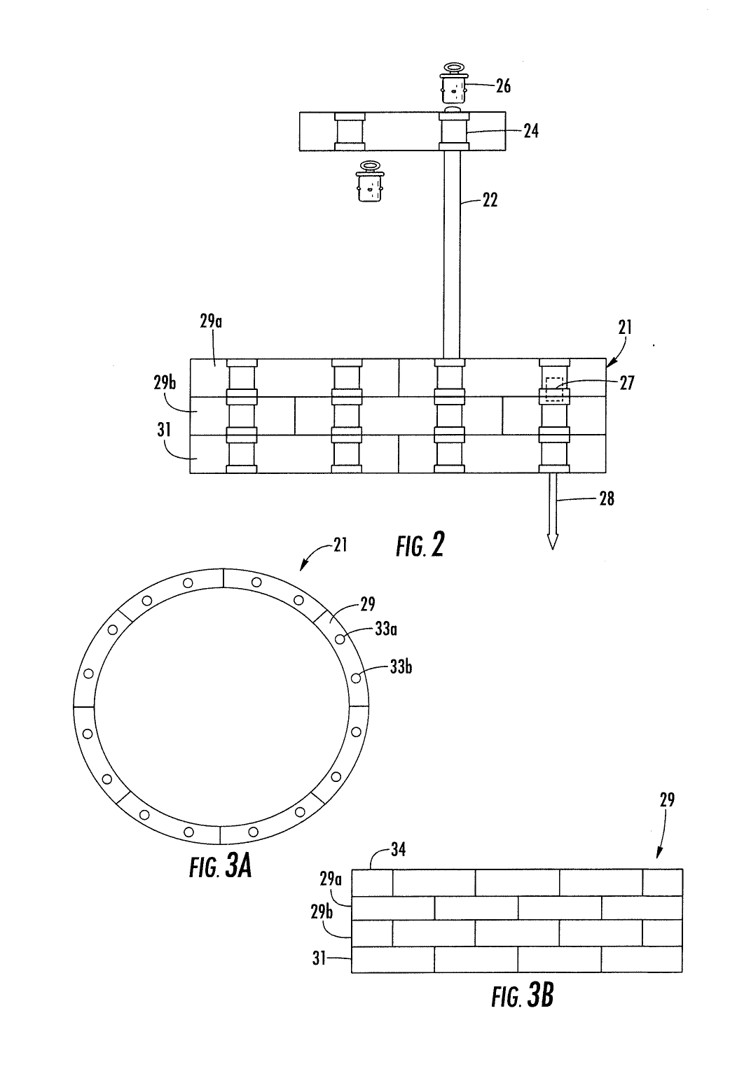

As perhaps best seen in FIG. 3B, when the cover layer 23 is stored long term, the circular base 21 includes only the bottom, the middle, and the upper blocks 29a-29b, 31, 34. The plurality of poles 22a-22d are removed, and the frost shield device 20 takes on the appearance of a typical paver block perimeter. In particular, when the cover layer 23 is deployed, the upper blocks 34 are removed, exposing the through passageways in the middle blocks 29a-29b, and the plurality of poles 22a-22d is inserted into the exposed through passageways. The top ring 24 is assembled on the second ends of the poles 22a-22d, and the plugs 26 are installed in the exposed through passageways of the top ring. Thereafter, the cover layer 23 is draped over the poles 22a-22d, and affixed to the plugs 26, for example, with an elastic cord. It should be appreciated that although the illustrative embodiment includes only two rows of middle blocks 29a-29b, other embodiments may include only one row of middle blocks, or more than two rows of middle blocks.

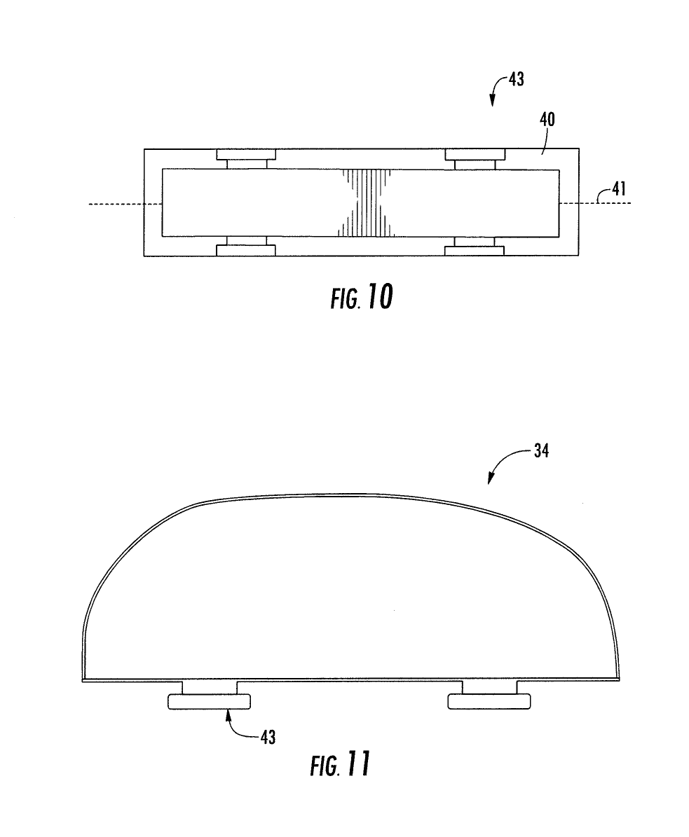

Indeed, as shown in FIG. 8, the upper blocks 34a-34c illustratively include a decorative textured outer surface. In this embodiment of the upper blocks 34a-34c, each upper block has a cross-sectional U-shape so as to fit over the lower stack of middle and bottom blocks. In other words, when the upper blocks 34a-34c are in place (i.e. when the cover layer 23 and the poles 22a-22d are removed), the middle and lower blocks 29a-29b, 31 are hidden and circular base 21 has a complete look of natural stone.

As perhaps best seen in FIG. 3A, when the cover layer 23 is deployed, the upper blocks 34 are removed, and the plurality of poles 22a-22d is inserted through the through passageways 33a-33b in the exposed middle blocks 29a-29b. For the through passageways 33a-33b in the exposed middle blocks 29a-29b not occupied with respective poles 22a-22d, the plugs 26 are inserted into these open through passageways with an interface fit. The interface fit is provided by operation of the plurality of radial protrusions 35a-35d and corresponding radial indentations with through passageways 33a-33b.

The cover layer 23 illustratively includes a plurality of eyelets 25a-25c at a bottom thereof. The frost shield device 20 illustratively includes an elastic cord (not shown). When the cover layer 23 is in the extended position, the elastic cord is threaded through the plurality of eyelets 25a-25c in the cover layer and through the corresponding eyelets 37 of the plugs 26 fitted into the through passageways 33a-33b in the exposed middle blocks 29a-29b. Helpfully, this maintains the cover layer 23 in the extended position, even during adverse weather.

It should be appreciated that the cover layer 23 and the plurality of poles 22a-22d would be deployed for the winter season and removed during at the start of the spring. Positively, the cover layer 23 is exposed and open on the top, permitting light and rain water to continually feed the plant or tree while deployed. Moreover, the cover layer 23 permits formation of condensation thereon, further watering the plant during the dry winter season.

Referring now additionally to FIG. 9, the frost shield device 20 illustratively includes a vertical block connector 27. The vertical block connector 27 illustratively includes first and second opposing ends 43a-43b, and a medial portion 44 extending laterally greater than that of the first and second opposing ends. The vertical block connector 27 defines a through passageway 45 (shown with dashed lines) extending between the first and second opposing ends 43a-43b.

The vertical block connector 27 may include a compression mechanism comprising a plurality of grooves and opposing notches. The compression mechanism would permit the spacing between the first and second opposing ends 43a-43b to be changed, i.e. reduced or increased. Also, the vertical block connector 27 may be used in other applications.

As perhaps best seen in FIG. 2, the vertical block connector 27 is positioned within the through passageways 33a-33b of the middle block 29, and extending between vertically adjacent middle blocks. Each of the plurality of poles 22a-22d is inserted through the through passageway. Advantageously, the vertical block connector 27 provides for mechanical strength for the frost shield device 20.

Another aspect is directed to a method for making a frost shield device 20. The method may include providing a circular base 21 comprising a plurality of blocks 29a-29b, 31, 34, and forming at least some of the plurality of blocks each defining first and second through passageways 33a-33b, 39a-39b, and positioning a plurality of poles 22a-22d, each pole having a first end to be received by one of the first and second through passageways of the plurality of blocks, and a second end. The method may include positioning a top ring 24 to be coupled to the second ends of the plurality of poles 22a-22d, and providing a cover layer 23. The cover layer 23 is configured to extend from the circular base 21 to the top ring 24, thereby covering a plant within the circular base.

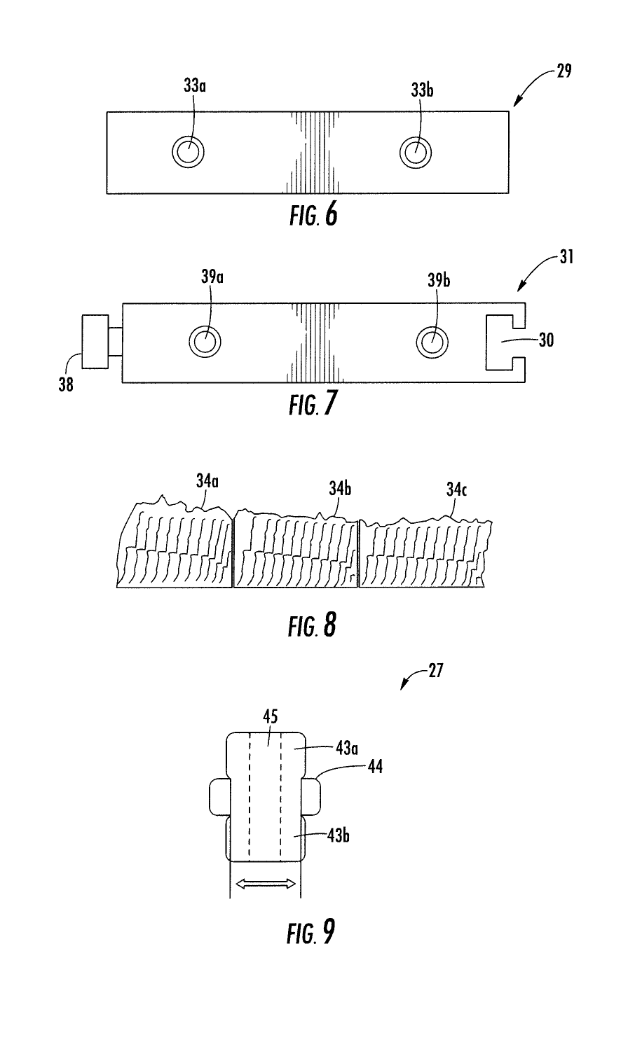

Referring now additionally to FIGS. 5A-5B, another embodiment of the plug 126 is now described. In this embodiment of the plug 126, those elements already discussed above with respect to FIGS. 4A-4B are incremented by 100 and most require no further discussion herein. This embodiment differs from the previous embodiment in that this plug 126 illustratively includes a spring band 135 carried by the lower body. In this embodiment, each of the middle blocks 129 and bottom blocks 131 includes corresponding radial recesses to receive the spring band 135.

FIGS. 10-11, a block hollowing jig device 43 is shown. The block hollowing jig device 43 is symmetric about an axis 41. The perimeter 40 noted represents the outer edge of a mold to form the block (e.g. an injection or pour mold). As will be appreciated, the blocks would be formed by placing the block hollowing jig device 43 within the block mold, and then pouring in the liquid polymer plastic material. As perhaps best seen in FIG. 11, the hollowing jig device 43 can be used to form the upper block 34.

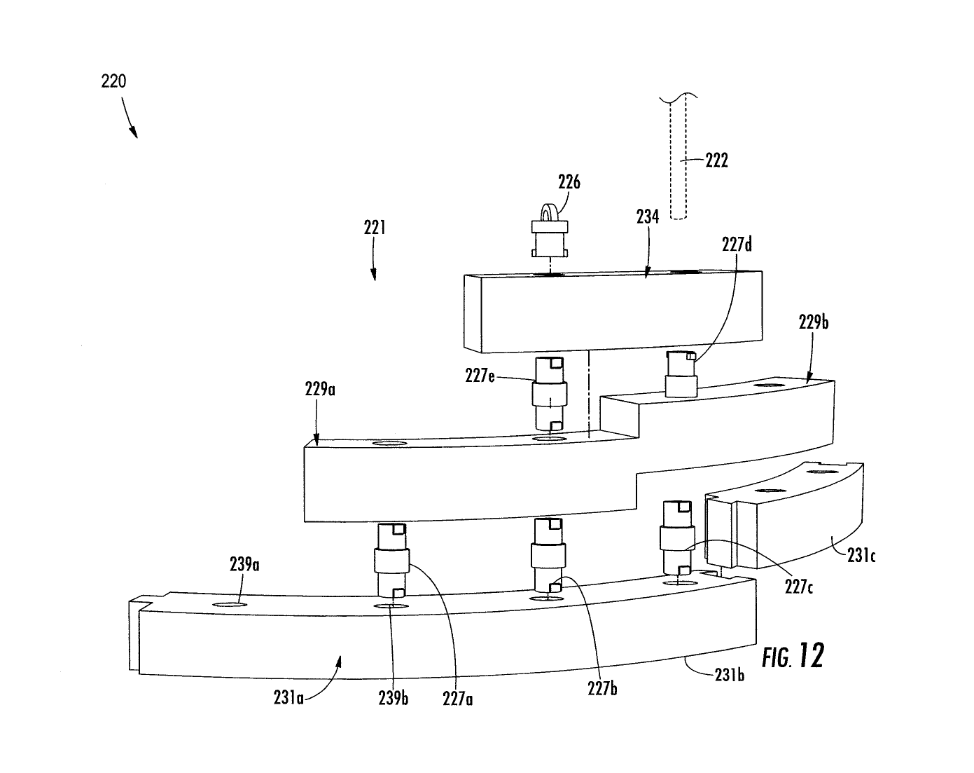

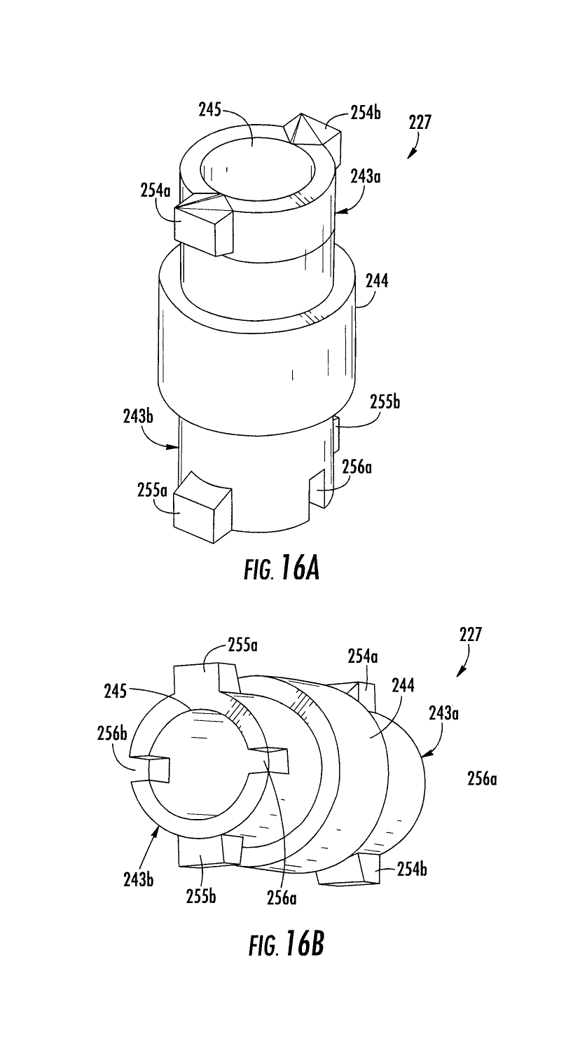

Referring now additionally to FIGS. 12-17B, another embodiment of the frost shield device 220 is now described. In this embodiment of the frost shield device 220, those elements already discussed above with respect to FIGS. 1-5B are incremented by 200 and most require no further discussion herein. This embodiment differs from the previous embodiment in that this frost shield device 220 illustratively includes a base 221 comprising a plurality of blocks 234, 229a-229b, 231a-231c. In this exemplary embodiment, each of the plurality of blocks 234, 229a-229b, 231a-231c defines a first through passageway 239a, 233a, 253a and a second through passageway 239b, 233b, 253b.

The frost shield device 220 illustratively comprises a plurality of poles 222. Each pole 222 has a first end to be received by one of the first through passageway 239a, 233a, 253a and the second through passageway 239b, 233b, 253b. The pole 222 also includes a second end opposite the first end. The frost shield device 220 illustratively includes a top ring coupled to the second ends of the plurality of poles 222, and a cover layer configured to extend from the base 221 to the top ring, thereby covering a plant within the base.

As perhaps best seen in FIG. 12, the plurality of blocks 234, 229a-229b, 231a-231c comprises a plurality of cap blocks 234, a plurality of base blocks 231a-231c, and a plurality of medial blocks 229a-229b between the plurality of cap blocks and the plurality of base blocks. Each base block 231a-231c illustratively comprises a first end 238 and a second end 230 opposing the first end defining an interlocking interface (e.g. the illustrated dovetail interface).

In the illustrated embodiment, the plurality of cap blocks 234 and the plurality of medial blocks 229a-229b are identical, and each illustratively comprises substantially flat ends. In other embodiments, these blocks may be different. For example, the plurality of cap blocks 234 may comprise an external decorative design, such as depicted in FIGS. 8 and 11. Also, although not depicted, the top ring may comprise a plurality of cap blocks, or base blocks.

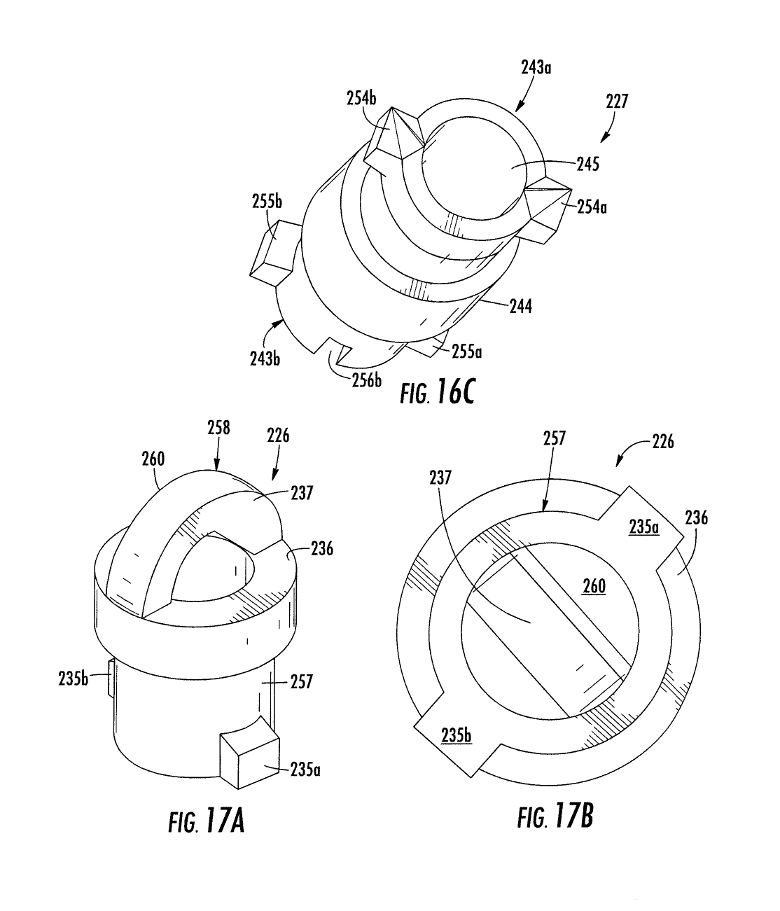

As perhaps best seen in FIGS. 16A-160, the frost shield device 220 illustratively includes a plurality of connectors 227a-227e carried within the first through passageway 233a, 239a and the second through passageway 233b, 239b of each base block 231a-231c and each medial block 229a-229b and vertically coupling adjacent blocks. Each of the plurality of connectors 227a-227e illustratively comprises an upper body 243a defining a plurality of upper radial protrusions 254a-254b, a lower body 243b defining a plurality of lower radial protrusions 255a-255b, and a disc-shaped medial portion 244 between the lower body and the upper body. The lower body 243b also illustratively comprises first and second radial slots 256a-256b radially spaced from the plurality of lower radial protrusions 255a-255b at approximately 90 degrees (i.e. ±5 degrees). Also, each of the plurality of connectors 227a-227e comprises a through passageway 245.

As perhaps best seen in FIGS. 17A-17B, the frost shield device 220 illustratively comprises a plurality of plug connectors 226 carried within the first through passageway 253a and the second through passageway 253b of each cap block 234. Each of the plurality of plug connectors 226 illustratively includes a lower body 257 defining a plurality of lower radial protrusions 235a-235b, an upper body 258 defining an eyelet 237, and a disc-shaped medial portion 236 between the lower body and the upper body. Also, each of the plurality of plug connectors 226 comprises a through passageway 260.

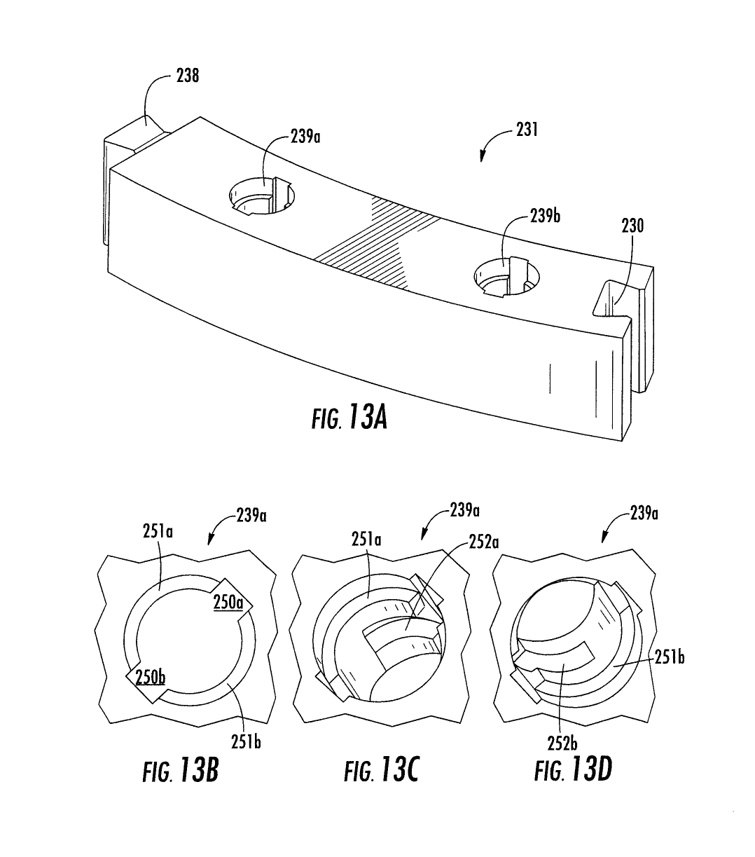

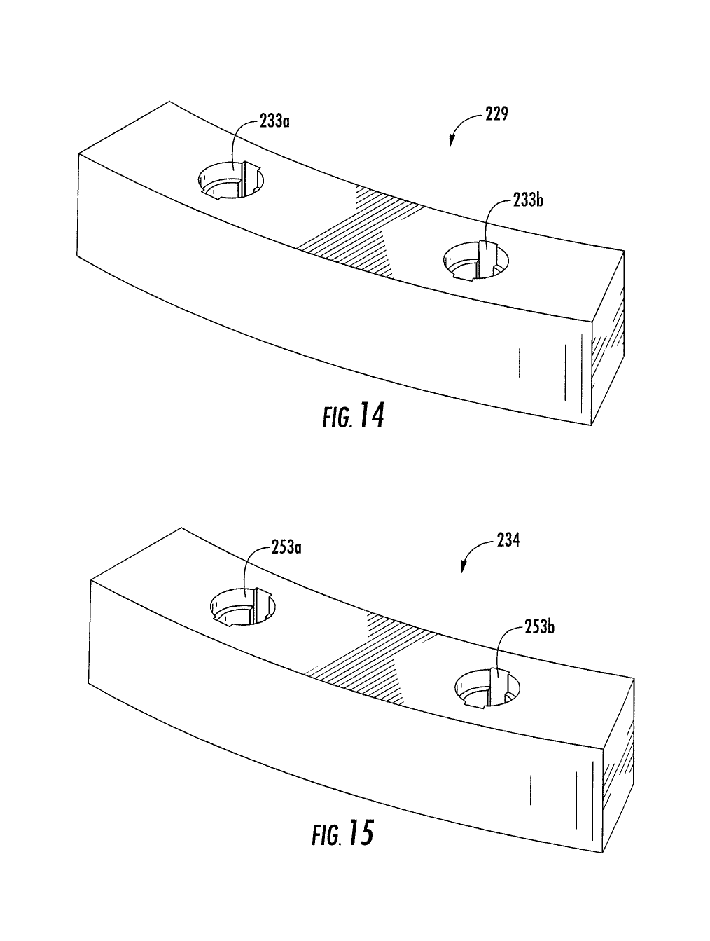

As perhaps best seen in FIGS. 13B-130, the first through passageway 239a illustratively comprises a radial shelf 251-251b partially extending about the through passageway. The radial shelf 251-251b illustratively defines an outer diameter (i.e. an outer radial wall), and an inner diameter (i.e. an inner radial wall) less than the outer diameter. The first through passageway 239a illustratively comprises first and second opposing longitudinal channels 250a-250b extending completely therethrough, and first and second opposing medial channels 252a-252b extending transverse (i.e. extending radially approximately 90 degrees ±15 degrees) to the first through passageway 239a and being connected to the first and second opposing longitudinal channels. Although not shown for drawing simplicity, the second through passageway 239b of each base block 231a-231c includes identical features.

In the illustrated embodiment, the first through passageway 233a, 253a and the second through passageway 233b, 253b of each medial block 229a-229b and each cap block 234 have identical features to the first through passageway 239a. In other embodiments, the first through passageway 233a, 253a and the second through passageway 233b, 253b of each medial block 229a-229b and each cap block 234 have similar features, but include a pair of first and second opposing medial channels 252a-252b. More specifically, the first through passageway 233a, 253a and the second through passageway 233b, 253b would receive and interface lock with connectors 227a-227e and/or plug connectors 226 from opposing longitudinal sides, thereby providing a more mechanical strong connection. Of course, in some embodiments, such as the illustrated example, the first and second opposing medial channels 252a-252b are sized so to that the plurality of lower radial protrusions 255a-255b and the plurality of upper radial protrusions 254a-254b can concurrently fit therein.

As will be appreciated, the frost shield device 220 is assembled as now described. First, a first layer of the base blocks 231a-231c is assembled in the desired form for the base 221 (e.g. the illustrated circle shape). The adjacent first and second ends 238, 230 of the base blocks 231a-231c are coupled together via the interlocking interface.

Secondly, the plurality of connectors 227a-227e is inserted into the first through passageway 239a and the second through passageway 239b of the assembled base blocks 231a-231c. In particular, the lower body 243b of each connector is inserted in a respective through passageway 239a-239b so that the plurality of lower radial protrusions 255a-255b are aligned with the first and second opposing longitudinal channels 250a-250b and pass therethrough.

Once the plurality of lower radial protrusions 255a-255b reach a depth equal to the first and second opposing medial channels 252a-252b, the respective connector is rotated for a twist lock interface. In some embodiments, the medial blocks 229a-229b may be fitted over the upper body 243a of the connectors 227a-227e first, and then using a specialized wrench, the connector 227a-227e is rotated to lock the plurality of lower radial protrusions 255a-255b and the plurality of upper radial protrusions 254a-254b into their respective ones of the first and second opposing medial channels 252a-252b.

The medial blocks 229a-229b and the cap blocks 234 are assembled in similar fashion. Once the cap blocks 234 are fitted over the medial blocks 229a-229b, the plug connector 226 is inserted in some of the first and second through passageways 253a-253b of each cap block (except for those passageways intended to host a pole 222). In the other first and second through passageways 253a-253b, the pole 222 is inserted therein. Since the connectors 227a-227e and the plug connectors 226 include through passageways 245, 260, the pole can extend through them.

Another aspect is directed to a method of making the frost shield device 220. The method comprises forming a base 231 comprising a plurality of blocks 234, 229a-229b, 231a-231c. At least some of the plurality of blocks 234, 229a-229b, 231a-231c each defines a first through passageway 239a, 233a, 253a and a second through passageway 239b, 233b, 253b. The method comprises forming a plurality of poles 222, each pole having a first end to be received by one of the first through passageway 239a, 233a, 253a and the second through passageway 239b, 233b, 253b, and a second end, and coupling a top ring to the second ends of the plurality of poles. The method further comprises forming a cover layer configured to extend from the base 221 to the top ring, thereby covering a plant within the base.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A frost shield device comprising:
a base comprising a plurality of blocks;
at least some of said plurality of blocks each defining a first through passageway and a second through passageway;
a plurality of poles, each pole having
a first end to be received by one of said first through passageway and said second through passageway, and
a second end;
a top ring coupled to said second ends of said plurality of poles; and
a cover layer configured to extend from said base to said top ring, thereby covering a plant within said base.

2. The frost shield device of claim 1 wherein said plurality of blocks comprises a plurality of cap blocks, a plurality of base blocks, and a plurality of medial blocks between said plurality of cap blocks and said plurality of base blocks.

3. The frost shield device of claim 2 further comprising a plurality of plug connectors carried within said first through passageway and said second through passageway of each cap block.

4. The frost shield device of claim 3 wherein each of said plurality of plug connectors comprises a lower body defining a plurality of lower radial protrusions, an upper body defining an eyelet, and a disc-shaped medial portion between said lower body and said upper body.

5. The frost shield device of claim 2 further comprising a plurality of connectors carried within said first through passageway and said second through passageway of each base block and medial block and vertically coupling adjacent blocks.

6. The frost shield device of claim 5 wherein each of said plurality of connectors comprises a lower body defining a plurality of lower radial protrusions, an upper body defining a plurality of upper radial protrusions, and a disc-shaped medial portion between said lower body and said upper body.

7. The frost shield device of claim 2 wherein each base block comprises a first end and a second end opposing said first end defining an interlocking interface.

8. The frost shield device of claim I wherein each of said first and second through passageways has an outer diameter, and an inner diameter less than the outer diameter.

9. The frost shield device of claim 1 wherein each of said first and second through passageways has a longitudinal channel extending partially therein.

10. A frost shield device comprising:
a ring-shaped base comprising a plurality of blocks;
said plurality of blocks comprising a plurality of cap blocks, a plurality of base blocks, and a plurality of medial blocks between said plurality of cap blocks and said plurality of base blocks;
at least some of said plurality of blocks each defining a first through passageway and a second through passageway;
a plurality of poles, each pole having
a first end to be received by one of said first through passageway and said second through passageway, and
a second end;
a plurality of plug connectors carried within said first through passageway and said second through passageway of each cap block;
a plurality of connectors carried within said first through passageway and said second through passageway of each base block and medial block and vertically coupling adjacent blocks;
a top ring coupled to said second ends of said plurality of poles; and
a cover layer configured to extend from said ring-shaped base to said top ring, thereby covering a plant within said ring-shaped base.

11. The frost shield device of claim 10 wherein each of said plurality of plug connectors comprises a lower body defining a plurality of lower radial protrusions, an upper body defining an eyelet, and a disc-shaped medial portion between said lower body and said upper body.

12. The frost shield device of claim 10 wherein each of said plurality of connectors comprises a lower body defining a plurality of lower radial protrusions, an upper body defining a plurality of upper radial protrusions, and a disc-shaped medial portion between said lower body and said upper body.

13. The frost shield device of claim 10 wherein each base block comprises a first end and a second end opposing said first end defining an interlocking interface.

14. The frost shield device of claim 10 wherein each of said first and second through passageways has an outer diameter, and an inner diameter less than the outer diameter.

15. The frost shield device of claim 10 wherein each of said first and second through passageways has a longitudinal channel extending partially therein.

16. A method of making a frost shield device, the method comprising:
forming a base comprising a plurality of blocks;
at least some of the plurality of blocks each defining a first through passageway and a second through passageway;
forming a plurality of poles, each pole having
a first end to be received by one of the first through passageway and the second through passageway, and
a second end;
coupling a top ring to the second ends of the plurality of poles; and
forming a cover layer configured to extend from the base to the top ring, thereby covering a plant within the base.

17. The method of claim 16 wherein the plurality of blocks comprises a plurality of cap blocks, a plurality of base blocks, and a plurality of medial blocks between the plurality of cap blocks and the plurality of base blocks.

18. The method of claim 17 further comprising forming a plurality of plug connectors to be carried within the first through passageway and the second through passageway of each cap block.

19. The method of claim 18 wherein each of the plurality of plug connectors comprises a lower body defining a plurality of lower radial protrusions, an upper body defining an eyelet, and a disc-shaped medial portion between the lower body and the upper body.

20. The method of claim 17 further comprising forming a plurality of connectors to be carried within the first through passageway and the second through passageway of each base block and medial block and vertically coupling adjacent blocks.
